(19) United States
(12) Patent Application Publication
(10) Pub. No.: US 2005/0181118 A1
(43) Pub. Date: Aug. 18, 2005

(54) Method for the precision saturation of substrates in preparation for digital printing, and the substrates produced therefrom

(76) Inventors: Robert Allen Janssen, Alpahretta, GA (US); Gary Staley, La Canada, CA (US); Fred Noll, Roswell, GA (US); E. Tim McCraw, Duluth, GA (US); Alison Sayler Bagwell, Cumming, GA (US); Jerome James Workman JR., Brookiline, MA (US)

Correspondence Address: KIMBERLY-CLARK WORLDWIDE, INC., 401 NORTH LAKE STREET, NEENAH, WI, 54956, US

(21) Appl. No.: 10/978,097

(22) Filed: Oct. 29, 2004

Related U.S. Application Data
(60) Provisional application No. 60/544,228, filed on Feb. 12, 2004.

(51) Int. Cl. B05D 1/00

(52) U.S. Cl. 427/8

(57) ABSTRACT

A method for precisely applying a premetered amount of a composition into a textile substrate includes the steps of feeding a textile substrate into an application station, wherein the application station is desirably a reverse (indirect) rotogravure roll arrangement, applying a metered amount of a saturating solution to the textile substrate, while controlling the rate of speed of the substrate relative to the application station, monitoring the concentration of the solute in the textile substrate to assure a uniform level of saturation, desirably by use of an NIR evaluation, adjusting the application station to the extent necessary to assure uniform concentration of the solute on the textile substrate, and then drying the textile substrate.

Pursuant to 35 U.S.C. § 120 and/or 35 U.S.C. 119(e), Applicants hereby claim priority from presently copending U.S. Provisional Application No. 60/544,228 filed on Feb. 12, 2004.

### FIELD OF THE INVENTION

This invention pertains to the field of printing on substrates, including fabric substrates. More specifically, the invention pertains to methods for pretreating substrates to impart printability for a digital printing operation.

### BACKGROUND OF THE INVENTION

Substrates such as fabrics and paper, that are used for digital printing, i.e. ink jet printing using either thermal or piezo type print heads, require the addition of certain pretreatment chemicals to their surfaces or interstices in order to allow for high quality image printing. For the purposes of this application, the terms “fabrics” and “textiles” shall be used interchangeably and shall refer to woven, knitted and nonwoven substrate materials. The concentration level of the chemical additives in a substrate, and in particular a fabric substrate, must be carefully controlled so as to maximize the image performance properties that can be achieved using precise ink jet output from the various print heads. It has been found that there is a narrow concentration window that exists in which these chemicals can impart their optimal performance characteristics.

In the past, fabric pretreatment has been accomplished using “dip and squeeze”-type saturating processes. For instance, it has been common to use a method which submerses a fabric in a pan containing a saturating solution (feed solution). The excess solution is then squeezed out in a nip roller assembly, which is located above the dip pan. However, the dip and squeeze saturation method has proven to be inadequate, since it inefficiently uses a large amount of pretreatment chemicals, resulting in wasted resources. In particular, it requires a significant hold up volume of the saturating solution to “prime” the system, with the excess solution being squeezed back into the dip pan. The requirement that the hold up volume be large means that an excess amount of saturating solution must be formulated. For short saturation production runs, this method is inefficient, often resulting in solution waste. Further, the method requires considerable clean-up time when switching from one production run having one saturating solution, to another. For the purposes of this application, the term “production run” describes the process of saturating as much as several hundred yards of a fabric with a specific solution, and then quickly changing over to another fabric/solution system.

Another problem associated with the “dip and squeeze” saturation method is the concern that the excess saturating solution being squeezed back (squeeze out) into the feed solution may be of a different composition than the starting solution, since it may include materials from the substrate, or may be of a different concentration than the starting solution. This is not unusual since substrates often preferentially attract certain components from saturating solutions. This will result in a variable composition of the saturating solution as a function of the processing time, ultimately leading to less than optimal performance for textiles that are to be used in a printer. For these textiles, it is particularly important that the correct weight pick-up of the solution be highly controlled and maintained throughout the entire saturation process. This is necessary since the concentration of solutes in the textile has a direct bearing on the textile's print performance. Variable concentrations may result in poor print and stability attributes.

Other processes for precisely depositing compositions on textile substrates are known. However, such processes have heretofore been used primarily as coating applications. For instance, padding and gravure roll systems have been used to treat textiles, typically followed by a drying step. For example, U.S. Pat. No. 3,844,813 to Leonard et al. describes a precision deposition onto a textile substrate coating compositions by various gravure roll systems. This process fails to ensure that the solution is predictably and uniformly dispersed throughout the textile fabric, or at least on the targeted area (i.e. saturation). Further, the processes described in the Leonard reference are used to treat one side of a fabric substrate with a highly viscous coating. The patent indicates that such a system sometimes requires a physical “evening means”, such as a metering blade in close proximity to the applicator rolls, to insure complete coverage of the substrate in an even and uniform manner.

Finally, applicator roll processes have been used to impregnate fabrics with viscous fluids. For example, such methods are described in U.S. Pat. No. 1,558,271 to Newell. However, such processes have failed to include mechanisms to insure uniform penetration of such fluids throughout a fabric, or in a targeted region of a fabric, despite including fluid guides to physically direct fluid to specific locations on a fabric.

Therefore, there is a need in the printing area to both reduce the volume of the solution that is required to “prime” the saturating process as well as the flexibility to be able to switch production runs quickly. Further, there is a need in the printing area for a saturation method that demonstrates predictable and uniform distribution of solutes into a substrate, or a region of a substrate.

### SUMMARY OF THE INVENTION

Generally speaking, the present inventive process involves a method for precisely applying a premetered amount of a composition into a substrate, such as a textile or paper substrate, including the steps of feeding a substrate into an application station, wherein the application station is desirably a reverse (indirect) rotogravure roll arrangement, applying a metered amount of a saturating solution to the substrate, while controlling the rate of speed of the substrate relative to the application station, monitoring the concentration of the solute in the substrate to assure a uniform level of saturation, desirably by use of a near infra-red evaluation, adjusting the application station to the extent necessary to assure uniform concentration of the solute on the substrate, and then drying the substrate. In an alternate embodiment, the substrate may be laminated to a backing material prior to storage. In a further embodiment of the present invention the method includes a post treatment step to increase wicking in the material prior to monitoring. Such step may be a post metering squeeze or vacuum step. In still a further embodiment of the present inventive method, the pretreatment method includes a premoistening step, prior to premetering the substrate with saturating solution. In still a further embodiment of the present invention, the method includes a second application of a saturating solution from the previously untreated side of the substrate. This second application may be of the same saturation solution as the first treated side, or a different saturating solution.

### BRIEF DESCRIPTION OF THE DRAWINGS

FIG. 1 illustrates a schematic view of a dual reverse rotogravure roll system, illustrating an offset gravure process with reverse roll transfer, for pretreating a substrate with a saturating solution and monitoring the level of solutes in a pretreated textile fabric, in accordance with the present invention.

FIG. 2 is an alternate embodiment of the method of FIG. 1, illustrating a reverse rotogravure roll system for applying solute to both sides of a textile substrate, in accordance with the present invention.

FIG. 3 is a graph illustrating viscosity versus percent solids data for the cotton poplin saturating solution used in the present inventive method.

FIG. 4 is a graph illustrating viscosity versus percent solids data for the polyester poplin saturating solution used in the present inventive method.

FIG. 5 is a graph illustrating the overall absorption differences of near infrared (NIR) energy in the spectral region for the treated versus the untreated sides for the maximum (peak) frequency region near 4300 cm⁻¹ to 4290 cm⁻¹ minus the minimum region near 4550 cm⁻¹ on cotton.

FIG. 6 is a graph illustrating Spectral analysis of the saturated Cotton Poplin fabric, using the NIR scans showing the chemically treated front side as contrasted to the back side. The untreated control Cotton Poplin is the bottom curve.

FIG. 7 is a graph illustrating Spectral analysis of the saturated Polyester Poplin fabric, using the NIR scans showing the chemically treated front side as contrasted to the back side. The untreated control Polyester Poplin is the bottom curve.

FIG. 8 is a graph that illustrates the correlation of the dry weight add-on with the NIR absorbance (ΔAbs) data for the treated front side of the Polyester Poplin fabric.

FIG. 9 is a schematic illustrating the position of various NIR sensors as part of the inventive method.

### DETAILED DESCRIPTION OF THE INVENTION

A method to saturate substrates includes feeding a substrate such as paper or fabric into an application station containing a saturating solution, premetering the saturating solution onto the substrate, monitoring the concentration of saturant on the substrate and then drying the substrate. By premetering the saturating solution, as opposed to postmetering, it is possible to minimize and perhaps eliminate the subsequent waste and concentration variations associated with “squeeze out” of a dip and squeeze method. The premetering method may be accomplished using a variety of methods including rotogravure (offset gravure) techniques. Such rotogravure techniques can be pan or enclosed head applicator fed. Alternatively, they can be fed by a saturated nip, rotary screen, cascade, curtain or slot die applications. The slot die application may be configured to have the die touching the substrate or not touching the substrate (i.e. gapped) and the die may be located on the side of the substrate immediately opposite a roller or between two rollers. Desirably, the premetering approach utilizes an offset rotogravure roll arrangement, with reverse roll transfer.

Once the saturating solution has been premetered onto the respective substrate, it is monitored to determine/verify the appropriate amount of solute deposition on the substrate. If it is determined that a non-optimal amount of such solution has been deposited on the substrate, adjustments are made to the premetering mechanism in the saturation solution application station. Following the monitoring step, the substrate is dried in a drying station.

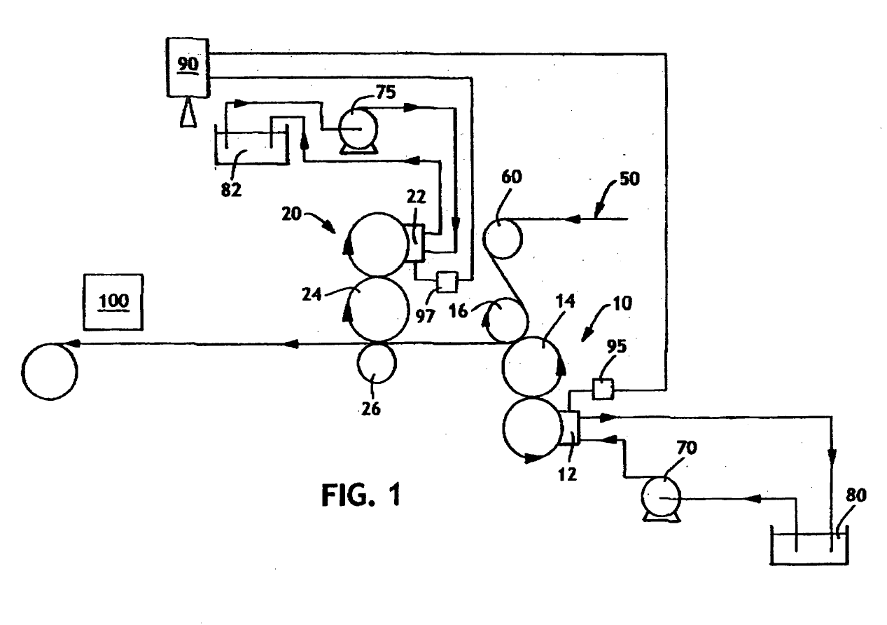

This method is generally illustrated in the FIG. 1, schematic including a dual offset rotogravure roll arrangement with reverse roll transfer, shown generally as application stations 10 and 20. It should be appreciated that while two application stations are shown on opposite sides of a moving substrate, the invention may include one or multiple application stations on the same or opposite sides of a substrate. For instance, several application stations may appear in sequence or series on the same side of a substrate to put down the same or different treatments onto the substrate. For the purposes of the examples which follow, only one application station was utilized.

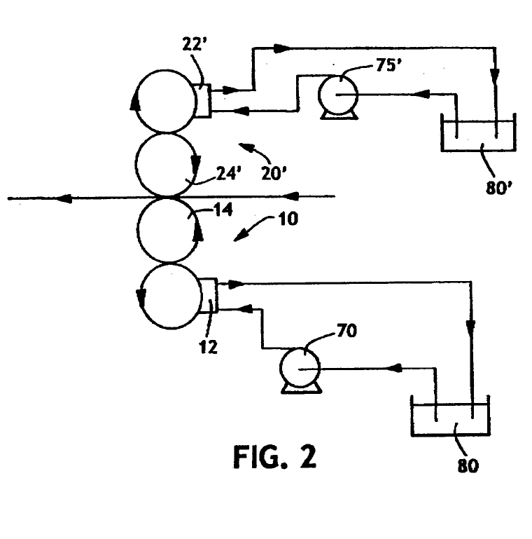

A second embodiment, shown in FIG. 2, illustrates an alternate configuration having two application stations on opposite sides of a web, without the use of backing rolls (as will be explained later). However, the arrangement as illustrated, includes enclosed head applicators 12 and 22 as part of a gravure roll arrangement.

Again, referring to FIG. 1, the offset gravure roll with enclosed head applicator is a standard roll such as that available from Southern Graphics. Such gravure rolls may be made of a variety of constructions, including ceramic and metallic materials. Desirably, such gravure roll is of a metallic construction including cells of a volume between about 1 and 200 billion cubic microns (BCM). Such cells may be in a variety of shapes, such as quad, z-flow, channeled, hexagonal and pyramidal. Reverse transfer rolls, 14 and 24 are situated adjacent to said rotogravure roll and operated to desirably rotate in the opposite direction to the rotogravure roll (reverse transfer mode). Desirably such transfer roll is composed of a metal including an outer shell of rubber, desirably 55 Shore A rubber. Such rubber transfer rolls help to allow the saturating solution to smooth out prior to impregnation into the substrate. Backing rolls 16 and 26 are situated adjacent to said transfer rolls 14 and 24 and serve to carry the substrate, i.e. textile, through the system.

In such a system, a substrate 50 is unwound from a winder (not shown) and passes around a guide roll 60 before being fed to backing roll 16. The substrate is typically under tension so as to avoid uneven saturation of the substrate in the process. Such tension is accomplished by dancers or nip pressure. Fabric substrates may require a separate fixture to hold the substrate in the correct alignment and with the proper cross-directional stretch, for leading up to the gravure roll application station. If a textile wrinkle should exist in the application nip, a non-uniform print image may result. For the purposes of this application, the term “cross-direction” shall refer to the direction perpendicular to the direction of the substrate through the process.

Alternatively, in such a system, a nip of web cleaning rolls may substitute for the guide roll, or be included in addition to the guide roll, in order to clean the substrate prior to it being saturated with solution. Such web cleaning rolls will help to remove lint or other waste substrate which may be present on the substrate so as to avoid inefficient operation of the gravure roll system. If present, the web cleaning rolls may be of a special polymer construction which grabs surface debris and loose threads, such as those available from Teknek. Such web cleaning rolls are typically operated at the same speed as the line speed (fabric unwind speed).

The saturating solution is pumped to the enclosed head gravure applicator rolls in the application stations, via standard pumps 70 and 75, such as a centrifugal, progressive cavity or gear pump. A power source powers the pump 70, but is not shown. The excess fluid is drained from the applicator roll to a container for holding saturating solution 80, 82. The backing rolls 16 and 26 are desirable chrome backing rolls. Desirably, both the transfer and backing rolls are operated at substrate line speed and in opposite rotational directions. For the method, the line speed, i.e. the speed of the fabric through the arrangement can be between about 5 and 3000 fmp. Desirably, the line speed is between 20 and 500 fpm. The speed of the rotogravure roll is normally operated between about +/−50 percent of the line speed. The speed of the transfer roll is desirably the same as the web line speed.

A monitoring device 90, desirably a near infrared monitor including a sensor (hereinafter NIR) is positioned between the backing roll and a drier 100, for monitoring the solute levels on the fabric. It is positioned to monitor solutes on the side facing the transfer roll. While the arrangement in FIG. 1 only shows one monitoring device, it is contemplated that a separate monitoring device would be positioned if desired, on both sides of the substrate, depending on the depth of analysis/observation by the NIR. While an NIR system is desired, other solute monitoring systems include ultraviolet, visible, near infrared, infrared, Raman, and X-ray fluorescence spectrometry. These techniques can be combined with photometry, scattering, gray scale imaging, reflectance, transmittance, and interactance to obtain equivalent results. A variety of sampling geometric configurations would be acceptable, however a 30-degree from normal specular reflectance technique is desirable due to its unique characteristic of surface sensitivity, as compared to diffuse reflectance and diffuse transmittance. The near infrared technique is optimal in that instrumentation can be made rugged for industrial use due to the use of simple optical designs and robust optical materials, viz. quartz or glass.

A variety of near infrared sensor manufacturers exist. These include, but are not limited to AM Tech Services Inc., Analyti Chem Corp., Boston Piezo-Optics, Bran & Luebbe Inc., Brimrose Corp. of America, Chemicon Inc., Electro Optical Products Corp., Encore Lab & Analytical, Infrared Fiber Systems, Isomet Corp., ABB Bomem Inc., Bio-Rad, Bloick Engineering, Bruker Optics Inc., Galileo Corp., Amattson Instruments Inc., Nicolet Instruments Corp., Ocean Optics.

Information obtained by the monitoring system may be manually read from the system, or electronically forwarded to the saturation solution application station as illustrated by electronic communication systems 95 and 97. The saturating solution application station (offset gravure roll arrangement) then may be manually adjusted to compensate for the desired solute level on the fabric, or electronically directed to compensate for the desired solute concentration on the fabric.

While other means of monitoring may be used with the inventive method, it has been found that the NIR method has proven particularly effective. In this regard, a near infrared test method was developed to quantify the organic material added to polyester poplin and cotton poplin fabrics since the analytical method is sensitive to the level of added material onto the surface of fabrics. Standard spectroscopic measurement practice utilizes diffuse reflectance or diffuse transmittance. These optical measurement geometries are sensitive to the total chemical composition of a thick sample but are not surface sensitive.

Attenuated total reflectance is also commonly used for surface spectroscopic analysis, but this technique requires that the sample be in direct physical contact with the measuring crystal and thus this technique is not suited to on-line analysis.

The selected measurement technique specifies a 30-degree incidence and collection specular reflectance technique. The technique has been found to provide surface sensitive measurements for diffusely reflecting samples. Specular reflectance is typically used for specularly reflecting surfaces, such as mirrors or metallic objects in a laboratory setting, to determine surface properties of highly reflective surfaces.

The NIR sensor can therefore be successfully used as an on-line monitor. When the degree of saturation of the fabric starts to deviate from a desired range, the sensor would detect this change and send a signal to an operator, or the application station (saturator), so as to make an adjustment in the process. As stated, this could be done by either manual or automatic interfacing for in-process control.

The near infrared sensors used can be of a single sampling point type (as described and tested), where either the sensor is itself moved spatially over the surface of the treated substrate; or the treated substrate is moved relative to the sensor. The measurements thus obtained can be reconstructed into data indicative of the treatment quantity or efficacy. Alternatively, the sensors employed can also be of the line-scan type, utilizing a linear array detector, or a two dimensional type, utilizing a two-dimensional array detector. These array sensor types could be utilized for constructing real-time images of the treatment chemistry. The advantages of chemical images of the surface formed using array detectors is that they allow the operator to make treatment process adjustments manually or automatically based upon more detailed and more rapid information. This greater detail of surface information provided more rapidly leads to additional enhancement of the treatment process given a faster response time for making treatment process adjustments.

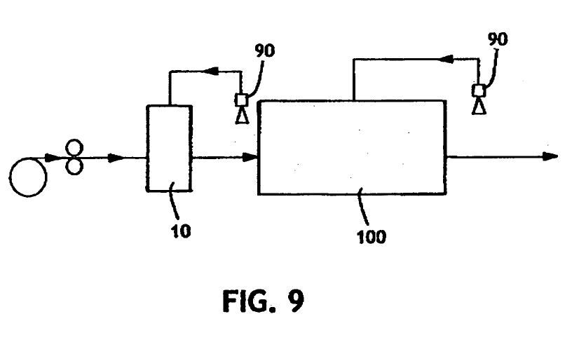

The NIR sensor is desirably located immediately after the saturating application station for faster response time as compared to monitoring the fabric after the drying oven, although this position would also accomplish the monitoring purpose. The NIR sensor can be adjusted so that the presence of water does not interfere with the detection of the print coat constituents in the saturating solution. Additionally, in a further alternate embodiment another NIR sensor can be located immediately following the drying station so as to monitor the degree of dryness in the textiles, by making it sensitive to the presence of water. Such is illustrated in FIG. 9, which also illustrates the substrate coming off a winder and passing through two cleaning rolls, prior to entering the application station 10.

Following monitoring to determine solute level on the fabric, the fabric is passed to the dryer 100. The dryer may comprise a standard oven or tenter frame dryer, and typically dries the substrate at temperatures between 100 and 400° F., depending on the types of substrate to be dried.

It has been found that the inventive process can be used to premeter saturating solution onto a variety of substrates including for example, fabrics, paper, nonwovens and films. Such fabrics include for example, cotton poplin, polyester poplin, Chiffon, Georgette, Nylon/Lycra, Silk, and Cellulose based substrates. Desirably, the viscosity of the solution that is to be applied to the substrates is greater than 100 cp, and more desirably, between 100 and 1000 cp. This of course would depend on the rheological characteristics of the specific saturating solution. In the examples which follow, the saturating solutions were run at viscosities of about 600 cp for the Cotton Poplin and 450 cp for the Polyester Poplin. Once the substrate has been dried, it may be wound up for storage onto a storage roll for further processing in-line (not shown). Alternatively, it may be laminated to a backing, such as a paper backing for ease of printing, when the substrate is to be run through an ink jet printer.

In an alternative embodiment of the inventive method of FIG. 1, as illustrated in FIG. 2, a second offset rotogravure with reverse transfer process may be used with the arrangement of FIG. 1. In this embodiment, a second offset rotogravure roll with enclosed applicator head 20′, similar to the rotogravure roll 20, receives saturating solution from a second pump 75′ and saturating solution source 80′. A second reverse transfer roll 24′ of a similar construction to the first transfer roll 24 receives saturating solution from the rotogravure roll and applies it to the opposite side of the substrate 50 to that applied by the first rotogravure roll arrangement. The substrate then continues on to the dryer as previously described. By utilizing two offset rotogravure rolls, the method can be used to apply the same or different saturating solution to each side of a fabric material.

Alternatively, the second offset rotogravure arrangement can be used to apply saturating solution to the same side of a substrate that has been previously treated if it is desired that multiple applications of saturating solution be done. It should be appreciated that a series of rolls may be positioned on either side of the substrate or on the same side.

In further embodiments of the inventive method, other optional process steps may be added to aid in processing of a textile substrate. Such additions include a post treatment squeeze step to help augment the wicking of the saturant into the treated fabric. It may be desirable to squeeze the solution into the textile, as opposed to out of the textile. This squeezing action may be accomplished by either a nip roller arrangement or by the application of a vacuum to the coated substrate so as to pull the solution into the substrate. This vacuum and/or nip augments the wicking action of the substrate in addition to producing a more uniform concentration of the saturating solution across the substrate width. Further, since the solutes in the saturating solution may be located primarily on the outside surface of textile fibers in a substrate, these further spreading steps help amplify the ability of the substrate to demonstrate an enhanced printing surface.

Additionally, a premoistening step may be added to the process to moisten a fabric substrate prior to saturation. By adding a predetermined amount of moisture to the textile, the ability of the solution to penetrate the substrate could be increased, leading to a more controlled and predictable process. The moisture can be added through a dip process, atomization of water onto the fabric, or by having the fabric exposed to a controlled humidity prior to having the saturating solution applied to the textile. Further processing step additions may include a Corona treater and ultraviolet light station for creating a surface on the substrate, which is more polar (to result in a better wetting of the impregnating solute) and for use in photocuring the impregnation solution. Still other additional process steps may include Infrared heating and or microwave exposure. In still a further embodiment of the inventive method, a lamination step can be added to the process for laminating the substrate to a backing layer. If such a lamination step is added, it may include unwinding a backing material, such as paper, available from American Biltrite. The backing material is fed into the nip of laminating rolls. Desirably, the backing material is constructed from paper with either a heat or pressure activated adhesive. Both the treated fabric and backing would then be pressed together under nip pressure/heat to create a laminate. The laminate product can then be wound onto a roll for storage. By laminating the fabric to a backing layer, the material can then be easily fed into ink jet printers.

Finally, the present invention further includes pretreated substrates made in accordance with the previously described methods.

The present invention is further described by the examples which follow. Such examples, however, are not to be construed as limiting in any way either the spirit of the scope of the present invention. Unless otherwise stated, all percents are percents by weights.

### TRIAL EXAMPLES

The performance properties and suitability of the offset rotogravure reverse transfer process was evaluated for the precision saturation of Cotton and Polyester Poplin fabrics. Various gravure application modes and configurations were evaluated. Further, the quantitative pick-up of the saturating solution on these treated fabrics was determined along with their digital imaging performances. Finally, the concentration gradient of the applied chemicals through the fabrics was also quantified.

The Cotton Poplin was purchased from Lorber Industries under code/style number 9680, having a plain weave construction. The Cotton Poplin sample had a measured basis weight of 124 grams per square meter (gsm). It was wound up on a 2 inch core, and the fabric had a width of approximately 15 inches. The Polyester Poplin fabric was purchased from Fisher Textiles under code/style number PP6248, having a plain Weave construction. It had a measured basis weight of 175 gsm. It was wound up on a 2 inch core and the fabric had a width of approximately 11.5 inches.

The method utilized an offset rotogravure arrangement with reverse roll transfer that contained an enclosed head applicator similar to that shown in FIG. 1, except that the treatment was only applied to one side of the substrate. Specifically, the system included an enclosed head applicator with a transfer roll composed of an outer shell of 55 Shore A hardness rubber. The gravure and transfer rolls were operating in the reverse direction transfer mode. However, both the transfer and backing roll were operated at web line speed of 25 fpm. The specific gravure roll that was used was made by Southern Graphic System and had a designation of H2. It was of the tri-helix design and had a theoretical cell volume of 69.5 billion cubic microns (BCM) per square inch with a depth of 190 microns. Southern Graphics Systems specifications show that it had 24 lines per inch at a 35 degree angle.

The gravure roll was filled with the saturating solution through the enclosed head applicator. For a 60 inch wide web, the applicator would have a hold-up volume of approximately 5 gallons. This is not a significant amount of solution and can be easily accommodated for in the formulation stage.

By using the reverse transfer mode, the feed rate of the saturating solution to the transfer roll at the nip interface could be varied easily. By increasing the speed of the gravure roll, more solution will be available to the web per unit area. This allows for in-process adjustments when a web is being saturated to a specific level.

The rubber transfer roll and chrome backing roll were operated at web line speed (25 fpm) and in opposite directions. Reverse roll transfer at this point in the process would result in damage to the fibers in fibrous fabric web. If the gravure roll had been in direct contact with the web, this would have necessitated that it be operated at line speed since web damage would otherwise result. Therefore, keeping the web and gravure roll at a synchronized peripheral speed would not give the advantage of being able to adjust the solution delivery rate as can be obtained with the reverse transfer mode.

The rubber transfer roll also allowed the saturating solution to “smooth out” prior to impregnating into the web. Further, the gravure roll design used for these examples would not result in a uniform lay down of the solution to the web, if a direct transfer had been used. This is the result of the coarse tri-helix cell in the gravure roll, which would generate an irregular saturation pattern on the textile, and thereby produce a non-uniform printed image. It should be noted that the backing roll was chrome plated to allow for the effective transfer of the solution to the textile being processed.

For the purposes of this application, the terms “front side” and “treated side” of the saturated textile shall have the same meaning and shall describe the side of the textile that comes into contact with the rubber transfer roll and therefore comes into direct contact with the applied solution. The “back side” or “untreated side” shall have the same meaning and shall refer to the side of the textile that comes into contact with the chrome backing roll.

Subsequent to the saturation of a specific fabric, the fabric was first dried in a 60 foot forced air oven. Hot air at 150° F. was used with direct impingement on top of the fabric with air bars at the bottom. A constant line speed of 25 feet per minute was used for all trials. The fabric was not supported in any way through the dryer section except by idler rollers.

Two stock solutions were prepared for the saturation of the fabrics, one for the Cotton Poplin and the other for the Polyester Poplin. These solutions were made in a concentrated form, giving the flexibility to adjust the viscosity of the solution so as to select the appropriate concentration for the processing conditions. The concentrated solution for the Cotton Poplin saturating solution is summarized in the following Table I:

TABLE I
Concentrated Cotton Poplin Saturating Solution

| | | | BATCH |
|---|---|---|---|
| INGREDIENT | SOURCE | % SOLIDS | SIZE (POUNDS) |
| Water | — | — | 40 |
| CP 7091RV | Calgon Corp. | 49.30 | 33.6 |
| Varisoft 222 LM | Witco | 90.0 | 14.7 |
| Print Rite 591 | BF Goodrich | 43.50 | 76.1 |
| Air Flex 540 | Air Products | 55.17 | 60.0 |

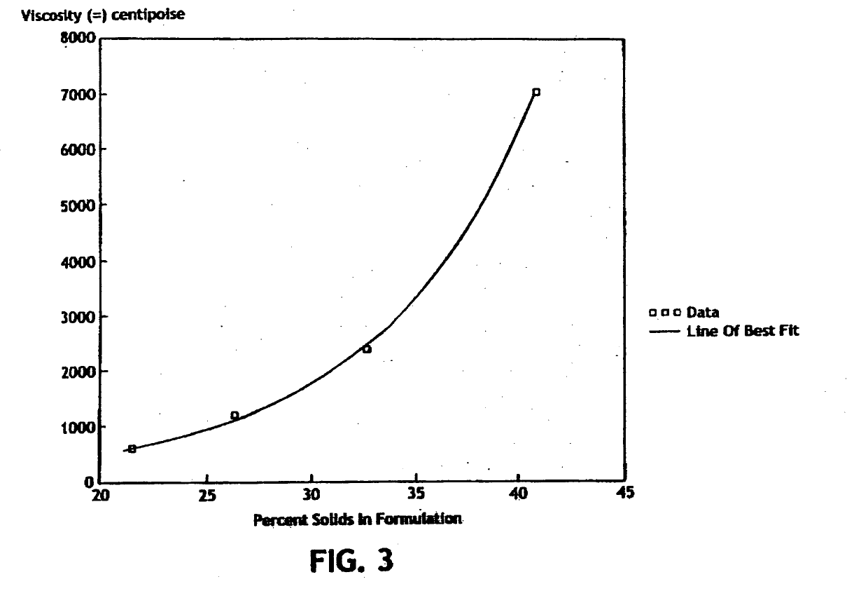

Each ingredient was added, with stirring, to a 50 gallon drum in the order of the sequencing listed in the table. Water was added first followed by the other components. The saturation solution included water as a carrier, a cationic polymer, i.e. CP 7091 RV, available from Calgon Corp., a fabric softener, i.e. Varisoft 222 LM, available from Witco, a binder, i.e. PrintRite 591, available from BF Goodrich and a binder, i.e. Air Flex 540, available from Air Products. The analytically determined solids in the solution was 40.9 percent. This was determined by evaporation of liquids to determine a dry amount. Portions of the above solution were diluted with water to various solids content. The viscosity of these solutions were then determined by using a RVF model Brookfield viscometer using operating procedures provided in the user's manual. The number 3 spindle was used for all measurements. This data is summarized on the Graph of FIG. 3.

The concentrated solution for the Polyester Poplin is summarized in the following Table II:

TABLE II
Concentrated Polyester Poplin Saturating Solution

| | | | BATCH |
|---|---|---|---|
| INGREDIENT | SOURCE | % SOLIDS | SIZE (POUNDS) |
| Water | — | — | 48.6 |
| CP 7091RV | Calgon Corp. | 49.30 | 54.1 |
| Varisoft 222 LM | Witco | 90.0 | 11.8 |
| Air Flex 540 | Air Products | 55.17 | 193.3 |

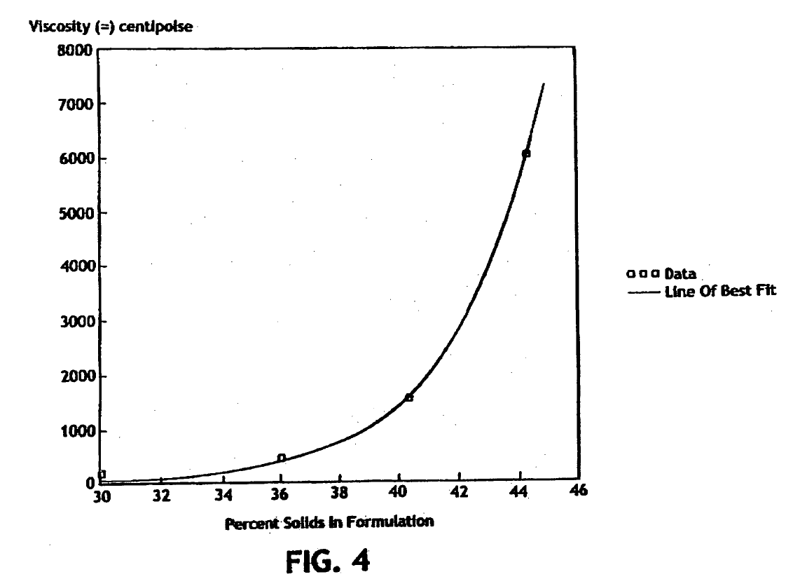

The order of addition for the ingredients were as they are sequenced in Table II with continuous stirring. The analytically determined solids in the solution was 44.4%. Portions of the above solution were diluted with water to various solids content. The viscosity of these solutions was then determined using the same procedure as described above. This is summarized on the Graph in FIG. 4.

A saturation trial in which a fire retardant was added to the Polyester Poplin was also conducted. The specific fire retardant used was from BF Goodrich and had a trade name of Pyrosan SYN and is composed of dialkyl alkyl phosphonate esters.

For each of the examples, monitoring of the solute concentration on the fabric samples was conducted using the NIR method, and in particular, with the use of a Bruker Model FTS-66 FT-NIR, available from Bruker Optics Inc., 19 Fortune Dr., Manning Park, Billerica, Mass. 01821. The measurements were made at 16 cm⁻¹ resolution and 3 minute scan time. A 30-degree specular reflectance accessory available from Pike Technologies, 2919 Commerce Park Dr., Madison, Wis. 53719 was used with gold-coated mirror for the background reference and as the background for a single layer thickness measurement.

Analysis of the saturated fabric by near infrared (NIR) allowed the quantification of the print coat chemicals on both the front and back surfaces of the saturated textiles. The measurement conditions were as described in the following Table III.

TABLE III
Measurement Conditions Using NIR Test Method

| NIR MEASUREMENT | |
|---|---|
| CONDITION | CONDITION VALUE |
| Spectral Range | 12000 cm⁻¹ to 3498 cm⁻¹ |
| Data Points | 3498 |
| Source | Tungsten-halogen |
| Detector | NIR-PE |
| Beamsplitter | KBr |
| Phase Resolution | 128 |
| Phase Correction | Power Spectrum |
| Apodization | Blackman-Harris 4-term |
| Zero filling factor | 4 |
| Resolution | 16 cm⁻¹ |
| Specular Reflectance Accessory | 30° incidence and reflectance angle |
| Data collection | 3 minute(215 co-added scans per |
| | measurement) |
| Reflectance mirror used | Gold-coated |
| for background reference | |

It should be noted that it is possible to display the print coat chemicals in terms of machine or cross-directional data or images that could be appropriately processed into digital output data or map images for precise control of the saturation process. The output information relative to the print coat chemical can be tied to a DCS (distributive control system) capable of manual or automated process control.

Sample Measurement

The gold mirror was measured as the reference material prior to the measurement of all test samples. The samples were then placed onto the reflectance accessory and each side measured separately and reported as
Absorbance=−log₁₀ Reflectance

Measurements were taken using special operating procedures so as to optimize the surface signal and signal-to-noise of the print coat chemical at the substrate exterior plane. The unique combination of measurement conditions and geometry allows high quality quantitative data to be measured relative to surface chemical addition. The 16 wave number resolution provides sufficient resolution with enhanced signal so as to optimize the overall quality of the data for quantitative use.

The absorbance differences for the treated versus the untreated sides are reported for the maximum (peak) frequency region near 4300 cm⁻¹ to 4290 cm⁻¹ minus the minimum region near 4550 cm⁻¹. This calculation was performed for the test sample and a control sample. The final absorbance signal difference was reported as
ΔA Front Side=(Test sample Front side minus control)
ΔA Back Side=(Test sample Back side minus control)

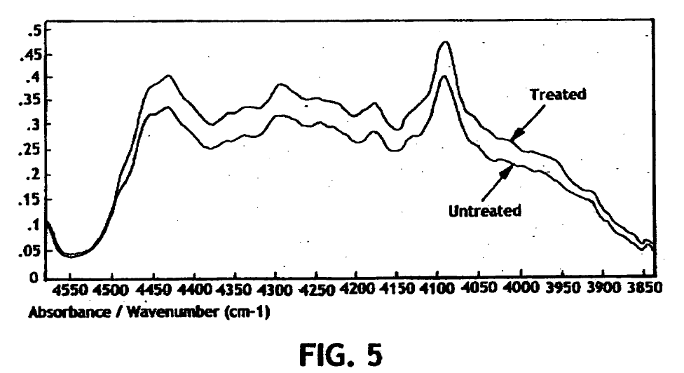

The overall absorbance difference was found to be proportional to the concentration of add-on material. The NIR spectral region of 4300 cm⁻¹ corresponds to the presence of the CH stretch/C—H deformation from the chemical treatment near the surface. The overall absorption of NIR energy in this spectral region indicates the increased presence of C—H bonds from the treatment chemicals at, or near, the surface as shown in FIG. 5, which demonstrates absorbance of a treated side (top curve) versus an untreated side (bottom curve).

The use of a 30 degree specular reflectance measurement geometry combined with near infrared energy allowed the coating properties of this process to be determined. The aspects of the partitioning of the add-on chemicals was measurable using this detection geometry, whereas conventional on-line (meaning in the processing line) techniques would not be as sensitive to the surface deposition aspects of this printing process.

The system therefore allows for real-time measurement of the add-on process during manufacturing. This would allow properties of the manufacturing process to be controlled during manufacturing.

After the saturation trials were concluded, the respective fabrics were printed using either Encad GS or GO inks, dispensed from a Pro-E printer on Tyvek settings. These inks were comprised of a blend of acid, direct, and reactive dyes available from Encad. The GS inks were made from liquid dyes and were used to evaluate the print coat on both the Cotton Poplin and Polyester Poplin textiles, whereas, the GO inks are formulated from pigments and were used to characterize the effect a fire retardant has on the print coat performance.

Color properties on the imaged textiles were measured using an X-Rite 938 spectrodensitometer instrument. The standard operating procedures of the instrument were followed. The illuminant was D65 at a 2° angle. The determined C.I.E. L*,a*,b* values^{(1,2)} describe the location of the color on a three dimensional diagram. The CIE is the Commission Internationale De L'eclairage (a.k.a. the International Commission on Illumination, and the Internationale Beleuchtungskommission) The main publications covering the use of this measurement include: (1) Publication CIE No 15.2 (1986), Central Bureau of the CIE, A-1033 Vienna, P. O. BOX 169—Austria and (2) ASTM E 308-90, Standard Test Method for Computing the Colors of Objects by Using the CIE System, American Society for Testing and Materials, 100 Barr Harbor Drive, West Conshohocken, Pa. 19428-2959 USA. The data is represented by CIE LAB values in the tables.

Investigation of Cotton Poplin Fabric

Cotton Poplin was the first fabric processed using this method. A solids concentration of 21.6% was used in the operation. This resulted in a viscosity of 600 centipoise (cp) in the saturating solution. The resulting dry weight pick-up for this run was nominally 11 percent (%). This varied by no more than ±0.1% over the entire length of the run, which was about 200 feet. For the purposes of this application dry-weight pick-up is calculated using the following equation:

$$\frac{Dry Weight of Saturated Fabric \text{-} Dry Weight of Unsaturated Fabric}{Dry Weight of Unsaturated Fabric} \qquad ( 100 )$$

This level of control would assist in achieving the optimal image quality that would result from the precise ink jet output. Using the 11% dry weight add-on for this fabric, the following calculations yield the total weight of the saturating solution that was impregnated into one square meter of the fabric. The fabric had a basis weight of 124 gsm (grams per square meter).
0.11×124 gsm=13.6 grams of solids was impregnated into one square meter of the textile.
13.6/0.216=63 grams of the saturating solution (21.6% total solids) was delivered to one square meter of the Cotton Poplin.

That is, the conditions that were used for this trial resulted in the gravure roll delivering 63 gsm of the saturating solution to the Cotton Poplin fabric. As previously, mentioned, the gravure roll used for this study had a theoretical cell volume of 69.5 BCM per square inch. Converting this volume per unit area to grams of solution, using a solution density of 1.0 gram/cm³, per square meter results in 108 gsm. This conversion is shown below.

Converting BCM to GSM

The specific gravure roll used in this study had a rating of 69.5 BCM per square inch.
1 BCM=1 billion cubic microns=1 billion micron³=1×10⁹ microns³

Assuming that the solution that occupies the cells in the gravure roll has a density of 1.0 grams/cm³, the following conversion applies:
(1 micron/1×10⁻⁶ M)³×(1 M/100 cm)³×(1 cm³/gram)=1 micron³/1×10⁻¹² grams
The above conversion states that 1 cubic micron of cell volume will hold 1×10¹² grams of saturating solution.
1 BCM=1×10⁹ microns³
Therefore:
1 BCM=(1×10⁹ microns³)×(1×10⁻¹² grams/micron³)=1×10⁻³ grams
The above conversion states the 1 BCM of cell volume will hold 1×10⁻³ grams of solution.

Converting square inches to square meters:
1 in²×(2.54 cm/in)²×(1 M/100 cm)²=6.45×10⁻⁴ M²
Therefore: 1 BCM/in²=1×10⁻³ grams/6.45×10⁻⁴ M²=1.55 GSM
Therefore: 69.5 BCM/in² converts to 108 GSM

Based upon reported values in the literature, the gravure rolls can deliver from between approximately 33 to 60% of the cell volume to a web. If the surface speed of the gravure roll is the same as the web speed, this would theoretically result in this specific roll delivering from 36 to 65 gsm. The peripheral velocity of the offset gravure roll was operating at a slightly greater velocity than the web speed, about 30% faster. However, it can go up to about 50% faster. However even with this velocity differential, the theoretically determined range approximates the 63 gsm calculated for the Cotton Poplin trial. This fabric then had a textile stripe onyx pattern printed on it using the GS inks dispensed from a Pro-E printer. The LAB color values were obtained at the beginning, middle and end of the 200 foot trial. This was measured on both surfaces of the fabric. As previously defined, the “front side” is the side of the fabric that was in contact with the rubber transfer roll. The “back side” is the side that was in contact with the chrome backing roll. The following Tables IV, V and VI summarize the results of color evaluation using the LAB measurements.

TABLE IV
CIE LAB Results For Cotton Poplin Trial
(BEGINNING OF TRIAL)

| | FRONT | FRONT | FRONT | BACK | BACK | BACK |
|---|---|---|---|---|---|---|
| COLOR | L | A | B | L | A | B |
| cyan | 62.04 | −25.66 | −26.14 | 61.59 | −26.98 | −26.24 |
| magenta | 46.94 | 54.52 | −5.53 | 48.01 | 52.62 | −4.88 |
| yellow | 85.12 | −0.96 | 82.24 | 85.71 | −0.64 | 79.91 |
| black | 30.17 | 2.17 | 1.23 | 31.46 | 1.80 | 1.17 |

TABLE V
CIE LAB Results For Cotton Poplin Trial
(MIDDLE OF TRIAL)

| | FRONT | FRONT | FRONT | BACK | BACK | BACK |
|---|---|---|---|---|---|---|
| COLOR | L | A | B | L | A | B |
| cyan | 62.22 | −25.89 | −26.12 | 61.47 | −26.82 | −26.39 |
| magenta | 47.20 | 54.34 | −5.50 | 48.05 | 53.25 | −5.20 |
| yellow | 85.22 | −0.85 | 83.07 | 85.77 | −0.64 | 80.60 |
| black | 30.33 | 2.10 | 1.50 | 31.02 | 1.86 | 1.24 |

TABLE VI
CIE LAB Results For Cotton Poplin Trial
(END OF TRIAL)

| | FRONT | FRONT | FRONT | BACK | BACK | BACK |
|---|---|---|---|---|---|---|
| COLOR | L | A | B | L | A | B |
| cyan | 62.41 | −25.88 | −26.71 | 62.27 | −26.74 | −26.38 |
| magenta | 47.64 | 54.90 | −5.66 | 48.32 | 54.05 | −5.31 |
| yellow | 85.68 | −0.74 | 83.03 | 85.69 | −0.55 | 80.91 |
| black | 29.07 | 2.04 | 1.53 | 30.19 | 1.68 | 1.33 |

As the data demonstrates, there was little change in the LAB results from the beginning to the end of the trial run. This correlates with the dry weight pick-up of the Cotton Poplin which varied by no more than ±0.1% points. This small color difference is insignificant to human visual perception, and is within the measurement error of the instrument. Further, there is little difference in the LAB measurements from the front to the back side of the Cotton Poplin.

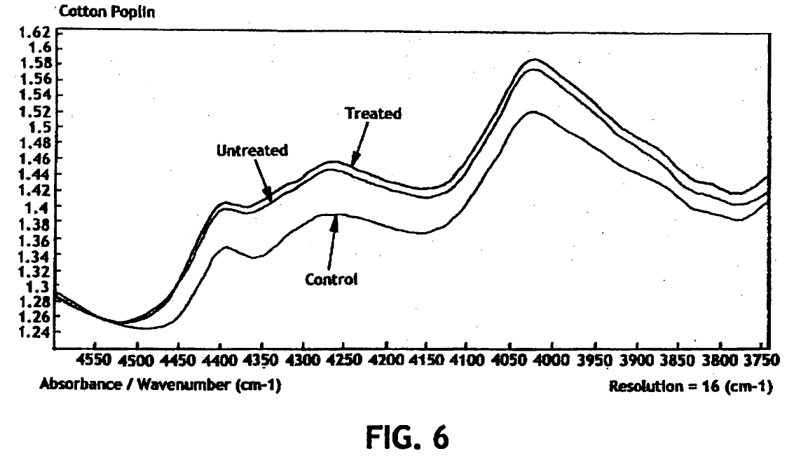

Spectral results, as obtained from the near infrared (NIR) scans, show that there is a difference between unsaturated and saturated Cotton Poplin fabric from this trial using the offset gravure method. These results are summarized in the graph of FIG. 6. Near infrared sensors aided in process control and in the measurement of surface chemistry on the cellulose and polymeric materials. For FIG. 6, the untreated fabric is represented by the bottom curve, with the top curve representing the treated side and the middle curve representing the untreated side. After saturation, the fabric shows a higher optical absorbance. More specifically, the absorbance values around the wave numbers from 4400 cm⁻¹ to 3900 cm⁻¹ are of particular interest. This range is the location the various functional groups in the print coat chemicals that were added to the fabric that would absorb.

Also, as FIG. 6 illustrates, there is a subtle difference in concentration of the print coat chemicals from the front to the back side of the Cotton Poplin (represented by the top two curves respectively). The front side, being slightly more concentrated than the back. The NIR results indicate that the treatment does produce similar results on the two surfaces of the Cotton Poplin, although the treated side has a slightly higher concentration of the added chemicals. Note that the absorbance signal at this wave number region is proportional to the amount of chemical treatment.

Table VII, which follows, summarizes the change in absorbance, at a wave number of 4300 cm⁻¹, for the specific treated side against the untreated Cotton Poplin fabric (control), as obtained from FIG. 6.

TABLE VII
Change In Absorbence For Cotton Poplin Trial Run

| | FRONT SIDE | BACK SIDE |
|---|---|---|
| NIR ANALYSIS | OF FABRIC | OF FABRIC |
| ΔAbs | 0.070 | 0.061 |

It should be noted that the fabric had an 11% dry weight add-on and that ΔAbs (change in absorbance) was determined at a wave number of 4300 cm⁻¹ and it is the absorbance of the specific treated surface minus that of the untreated Cotton Poplin fabric (control). Although being a small NIR optical difference between the front and back side for this fabric (0.009 Absorbance Units), as will be seen, this difference becomes more pronounced with the Polyester Poplin.

Investigation of Polyester Poplin

The next fabric that was investigated was the Polyester Poplin. A series of different sequences for saturating the fabric was simulated on the gravure roll set-up. However, the same concentration of the saturating solution was used for all the trials. The solution had 36.1% solids and a resulting viscosity of 450 cp. The first roll sequence consisted of using a single pass of the textile through the gravure configuration as previously shown in FIG. 1 (but for one application station). The nominal dry weight pick-up on the fabric was 12%. Again, this varied by no more than ±0.1% over the 200 foot length of the run. This reproduced the degree of precision that was observed in the Cotton Poplin trial.

Conducting a mass balance yields the gsm delivery of the saturating solution to the fabric, which has a basis weight of 175 gsm. The mathematics are as follows:
0.12×175 gsm=21 grams of solids was impregnated into one square meter of the fabric.
21/0.361=58 grams of the saturation solution (36.1% total solids) was delivered to one square meter of the Polyester Poplin.

Therefore, for this trial, the gravure roll was delivering 58 gsm of the saturating solution to the Polyester Poplin, which again, is in the range of the theoretically calculated value. The fabric then had a textile stripe onyx pattern printed on it using the GS inks dispensed from a Pro-E printer.

As with the Cotton Poplin trial previously discussed, CIE LAB color measurements were obtained at the beginning, middle and end of the 200 foot pilot trial. This is summarized on the following Tables VII, IX and X.

TABLE VIII
CIE LAB Results for Polyester Poplin
(BEGINNING OF TRIAL)

| | FRONT | FRONT | FRONT | BACK | BACK | BACK |
|---|---|---|---|---|---|---|
| COLOR | L | A | B | L | A | B |
| cyan | 54.19 | −14.25 | −39.29 | 60.23 | −11.06 | −31.31 |
| magenta | 48.43 | 57.21 | −7.58 | 55.52 | 44.07 | −7.04 |
| yellow | 85.96 | 1.35 | 82.00 | 86.85 | 3.12 | 59.14 |
| black | 27.01 | 1.99 | −0.81 | 42.46 | 1.33 | −0.77 |

TABLE IX
CIE LAB Results for Polyester Poplin
(MIDDLE OF TRIAL)

| | FRONT | FRONT | FRONT | BACK | BACK | BACK |
|---|---|---|---|---|---|---|
| COLOR | L | A | B | L | A | B |
| cyan | 54.59 | −15.85 | −38.59 | 62.05 | −11.19 | −29.73 |
| magenta | 48.83 | 56.60 | −7.87 | 58.29 | 40.11 | −7.04 |
| yellow | 86.02 | 1.35 | 81.20 | 87.16 | 3.42 | 56.28 |
| black | 27.27 | 1.81 | −0.98 | 42.65 | 1.36 | −0.77 |

TABLE X
CIE LAB Results for Polyester Poplin
(END OF TRIAL)

| | FRONT | FRONT | FRONT | BACK | BACK | BACK |
|---|---|---|---|---|---|---|
| COLOR | L | A | B | L | A | B |
| cyan | 54.86 | −16.19 | −38.50 | 61.69 | −12.98 | −30.78 |
| magenta | 49.28 | 55.78 | −8.03 | 56.81 | 42.85 | −7.23 |
| yellow | 86.01 | 2.04 | 80.08 | 86.93 | 3.41 | 57.66 |
| black | 27.37 | 1.87 | −0.74 | 44.92 | 1.23 | −0.43 |

As in the Cotton Poplin trial, the data demonstrates that there was little change in the CIE LAB results from the beginning to the end of the trial run for a specific side. However, significant difference in the CIE LAB data was observed when comparing the two surfaces of the Polyester textile. The specific CIE LAB values indicate that there were less print coat chemical constituents on the back side of the Polyester Poplin textile as compared to the front side.

The front side of the textile produced a sharp and intense image. In contrast, the printed back side was dull and faded, having the appearance of the fabric without the addition of the print coat formulation. This is consistent with the CIE LAB results.

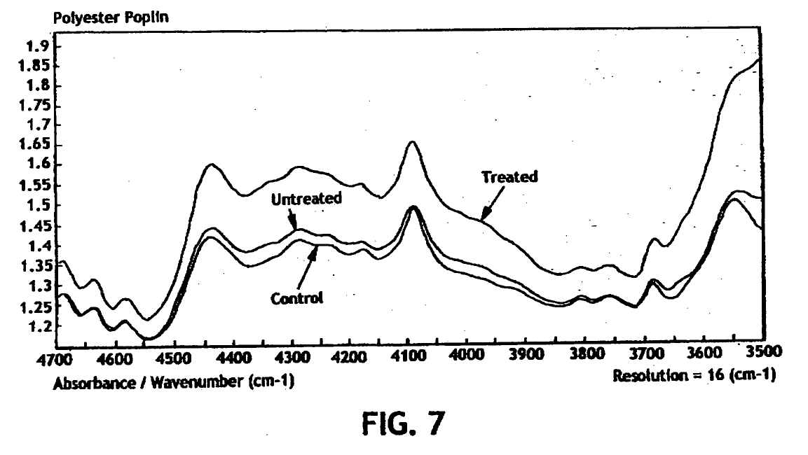

Spectral analysis of the saturated fabric, using the NIR scans, are presented on FIG. 7 showing the chemically treated front side as contrasted to the back side. The untreated control Polyester Poplin is the bottom curve as, in the previous FIG. 6. After chemical treatment the Polyester, the data reflects a higher level of NIR absorbance, indicating more chemical being present on the treated side of the material. The NIR wave number region of highest optical absorbance is indicated between 4450 cm⁻¹ and 3950 cm⁻¹. This region corresponds to where the chemical groups represented by the treatment absorb NIR energy.

As FIG. 7 also shows, there is much less chemical treatment on the untreated side than on the treated side, indicating that there is little migration of the chemicals through the Polyester. The majority of the chemicals remain on the treated surface. The absorbance signal at this wave number region is proportional to the amount of chemical treatment.

Table XI which follows, summarizes the change in absorbance, at a wave number of 4300 cm⁻¹, for a specific side against the untreated Polyester Poplin fabric (control), as obtained from FIG. 7.

TABLE XI
Change In Absorbence For Polyester Poplin Trial Run

| | FRONT SIDE | BACK SIDE |
|---|---|---|
| NIR ANALYSIS | OF FABRIC | OF FABRIC |
| ΔAbs | 0.100 | 0.025 |

It should be noted that the fabric had a 12% dry weight add-on. −ΔAbs (change in absorbance) was determined at a wave number of 4300 cm⁻¹ and it is the absorbance of the specific treated surface minus that of the untreated Polyester Poplin fabric (control).

The data in Table XI demonstrates there is a significant NIR optical difference between the front and back side of the Polyester Poplin (difference of 0.075 Absorbance Units). The back side appeared to have very little of the solutes in the saturating solution. Again, as for the Cotton Poplin samples, NIR spectral results correlate with the CIE LAB data and the visual quality of the printed image.

In a second set of trial examples, the additive effect on the dry weight pick-up was evaluated. During this trial, the Polyester Poplin was passed through the gravure arrangement two times. A series of gravure applicators was simulated by conducting two discrete passes on the same side of a textile substrate.

The dry weight add-on and NIR absorbance values are summarized in the following Table XII.

TABLE XII
Additive Effect Of Two Saturation's
On The Polyester Poplin Fabric

| | | SATURATION |
|---|---|---|
| MEASURED | SATURATION | (2 TIMES ON |
| PARAMETER | (1 TIME) | SAME SIDE) |
| Dry weight add-on | 8.6% | 17.8% |
| ΔAbs | 0.0704 | 0.146 |

It should be noted that ΔAbs (change in absorbance) was determined at a wave number of 4300 cm⁻¹ and it is the absorbance of the treated front surface minus that of the untreated Polyester Poplin fabric (control). As the data in Table XII demonstrates, the use of multiple passes through this offset gravure configuration will allow for added weight gain. The add-on could be to the same side of the textile or the opposite side. Additionally, the weight gain would be in direct proportion to the number of passes of the textile through the process. There were no observed processing issues associated with solution build-up on the transfer or backing roll. Additionally, the fabric retained its structural integrity through out the entire trial.

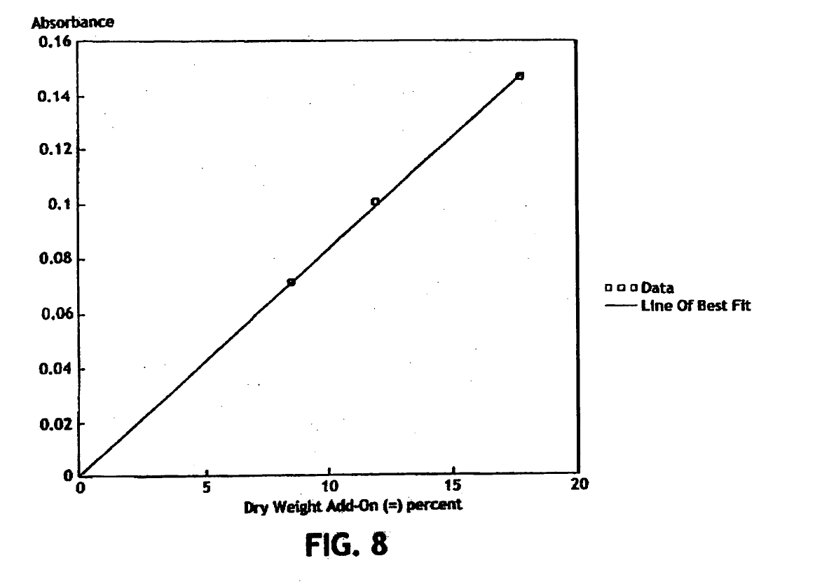

The correlation of the dry weight add-on with the NIR absorbance (ΔAbs) data for the treated front side of the fabric, as summarized in Tables XI and XII, is shown in FIG. 8. As can be seen a straight line results. Additionally, the line of best fit goes through the origin (0,0) which demonstrates that the dry weight gain is in direct proportion to the absorbance value (ΔAbs). ΔAbs=0.00822×(Percent Dry Weight Add-On) It should be noted that the absorbance values on the y-axis were determined at 4300 cm⁻¹. It is the absorbance of the treated front surface minus that of the untreated Polyester Poplin fabric (control). The values were obtained from Tables XI and XII. It is designated as ΔAbs in these tables.

Review of the absorbance data as summarized on Table XII demonstrates that the front side of the treated fabric (ΔAbs of 0.100) has 4 times the concentration of print coat chemicals when compared to the back side (ΔAbs of 0.025). This would imply that it should take less of the saturating chemicals to give the same surface printability as compared to a total saturation of the fabric which could result in cost savings in chemicals. The ability to keep these solutes more surface localized, could result in a textile with a better “feel”. The print coat chemicals do impart a certain degree of rigidity to the fabric, which is not desirable and which could be reduced by not allowing these chemicals to penetrate.

As previously discussed, the Polyester Poplin produces a two-sided fabric. The back side of the fabric contained very little of the print coat constituents whereas the front side retained most of it. Again, this was demonstrated through CIE LAB results, visual observation of the quality of the image and also NIR spectral analysis. This phenomena may be used advantageously for the addition of a fire retardant (FR) to this textile material in an alternate embodiment of the present method.

It is not uncommon for an inferior printed image to result when a FR is added to a print coat saturating solution. It has been discovered that if the FR was applied to one side of the fabric followed by the print coat to the other side, this problem can be circumvented.

A trial example was conducted on the Polyester Poplin using FR in addition to the saturating solution. The test consisted of adding the Pyrosan SYN fire retardant to the aqueous print coat solution. The fire retardant composed 20% of the total solids in the solution. The remainder 80% of the solids comprised the constituents in the print coat.

After application of the print coat/FR solution by the offset gravure method of FIG. 1 (one application station), the fabric was dried using a forced air dryer. This was then followed with the application of the print coat solution, without the FR on the non-treated side of the textile, and dried. The impregnation conditions were controlled so that the dry weight add-on was 9.0% for the print coat and 11.1% for the print coat/FR ingredients. This resulted in both sides receiving approximately the same quantity of print coat chemicals.

A textile stripe onyx image was then printed on both sides of the fabric using the GO inks from a Pro-E printer. One could visually observe the difference in the quality of the print when viewing the colors. The side that contained the FR produced a “sandy” like appearance. One way to quantify this observation is to calculate the color saturation of the Polyester Poplin. This is obtained from the “a” and “b” data of the LAB tests. Equation (1) quantifies this interaction.
S²=a²+b² (1)

The “S” term represents the color saturation of the fabric. The greater this value, the higher the color intensity will be. Tables XIII and XIV which follow, summarize the CIE LAB values, for green, yellow and red that were collected for the two surfaces of the saturated Polyester Poplin. The calculated “S” value is also presented for comparison.

TABLE XIII
Polyester Poplin Surface With The Applied Print Coat

| COLOR | L | A | B | S |
|---|---|---|---|---|
| green | 64.96 | −30.65 | 58.67 | 66.2 |
| yellow | 85.88 | 2.62 | 94.76 | 94.8 |
| red | 46.02 | 56.08 | 26.18 | 61.9 |

TABLE XIV
Polyester Poplin Surface With The
Applied Print Coat And Fire Retardant

| COLOR | L | A | B | S |
|---|---|---|---|---|
| green | 65.23 | −30.50 | 51.29 | 59.7 |
| yellow | 85.76 | 2.20 | 86.72 | 86.7 |
| red | 47.15 | 54.32 | 21.58 | 58.4 |

As the results indicate in both Tables XIII and XIV, the level of color saturation (S) has been measurably reduced with the presence of the fire retardant to the print coat. This also correlates with the visual examination of the imaged fabrics. The surface of the Polyester Poplin that contained the fire retardant and print coat chemicals produced an unacceptable printed image. However, the side with only the print coat resulted in an acceptable printed image. This embodiment of the inventive method therefore allows for the application of different saturating solutions to the respective surfaces of a specific textile without having them interfere with each other.

This could be accomplished with the use of two offset gravure rolls with reverse roll transfer applicators in series. As shown in FIG. 2, one station would apply the first saturating solution. The textile would then immediately go to the second station where a different solution would be applied to the opposite side of the web. Utilization of the saturation modes outlined in FIG. 2 allows for the independent control of the add-on to each side of the web, since the gravure rolls are offset from the web by means of the transfer roll. The gravure rolls can operate at a different peripheral velocity as compared to the web and thereby have variable solution delivery rates. This is a result of the opposite direction that the transfer and gravure rolls are operating at the nip interface. With this configuration, saturating solutions of both the same and different compositions can be applied to opposite sides of a web.

It therefore can be seen that the inventive methods require a small volume of solution to “prime” the system. For example, for a 60 inch wide web, this will be about 5 gallons. In particular, the offset gravure application mode lends itself to “short” production runs where the system must be easily cleaned up and changed to another fabric and saturating solution. By premetering the saturating solution onto the fabric via the gravure roll, there is little to no excess solution to squeeze back into the feed stream. This assures that the concentration of the solutes in the solution remained constant throughout a production run. High level of saturation precision for textiles may be accomplished and corroborated by dry weight pick-up (resulted in ±0.1 percent variation around the nominal), minimal variations in CIE LAB measurements on imaged textile, and perceived color difference. Furthermore, the method provides a monitoring and controlling means for the degree of saturation by using a near infrared sensor. Finally, a two-sided textile can be produced as a result of the chemical concentration gradient. That is, both surfaces can be saturated with two different solutions and each side will retain its specific and independent attributes.

While the invention has been described in detail with particular reference to the preferred embodiments thereof, it should be understood that many modifications and additions may be made thereto, in addition to those expressly recited, without departure from the spirit and scope of the invention as set forth in the following claims.

1. A method of precision saturation of a substrate comprising the steps of:
a. feeding a substrate into an application station,
b. applying a metered amount of a solute to the substrate, while controlling the rate of speed of the substrate relative to the application station,
c. monitoring the concentration of the solute on the substrate,
d. adjusting the application station to the extent necessary to ensure a substantially uniform concentration of the solute on the substrate; and
e. drying the substrate.

2. The method of claim 1 wherein said applying is accomplished by a method selected from the group consisting of rotogravure application, saturated nip application, rotary screen application, cascade application, curtain application, and slot die application.

3. The method of claim 2 wherein said applying is accomplished by an offset rotogravure arrangement with a reverse transfer roll.

4. The method of claim 2 wherein said applying is accomplished by a rotogravure application with a gravure roll made from ceramic or metallic materials.

5. The method of claim 4 wherein said roll is made from metallic materials and has cells in a shape selected from the group consisting of quad, z-flow, channeled, hexagonal and pyramidal and combinations thereof.

6. The method of claim 3 wherein said reverse transfer roll has an outer surface made of rubber.

7. The method of claim 1 further comprising cleaning the substrate prior to applying said solute to said substrate.

8. The method of claim 7 wherein said cleaning is accomplished with cleaning rolls.

9. The method of claim 1 wherein said rate of speed relative to the application station is between 20 and 500 fpm.

10. The method of claim 1 wherein said monitoring is accomplished by a method selected from the group consisting of near infrared monitoring, ultraviolet monitoring, visible light monitoring, infrared monitoring, Raman monitoring, and X-ray fluorescence spectrometry monitoring.

11. The method of claim 10 wherein said monitoring is performed in a 30 degree from normal specular reflectance technique.

12. The method of claim 10 wherein said monitoring is accomplished by near infrared monitoring and said monitoring occurs immediately after said applying.

13. The method of claim 12 further comprising the step of monitoring said substrate immediately after said drying.

14. The method of claim 1 wherein said substrate is selected from the group consisting of woven fabrics, nonwoven fabrics, papers and films.

15. A method of precision saturation of both sides of a substrate comprising the steps of:
a. feeding a substrate into a first application station,
b. applying a metered amount of a first solute to a first side of the substrate, while controlling the rate of speed of the substrate relative to the first application station,
c. monitoring the concentration of the first solute on the substrate,
d. adjusting the first application station to the extent necessary to ensure a substantially uniform concentration of the first solute on the first side of the substrate,
e. feeding the substrate into a second application station,
f. applying a metered amount of a second solute to a second side of the substrate, while controlling the rate of speed of the substrate relative to the second application station,
g. monitoring the concentration of the second solute on the substrate,
h. adjusting the application station to the extent necessary to ensure a substantially uniform concentration of the second solute on the second side of the substrate; and,
i. drying the substrate.

16. The method of claim 15 wherein said applying is accomplished by a method selected from the group consisting of rotogravure application, saturated nip application, rotary screen application, cascade application, curtain application, and slot die application.

17. The method of claim 15 further comprising the step of squeezing said substrate prior to drying, by a method selected from the group consisting of a nip roller arrangement or by the application of a vacuum.

18. The method of claim 15 further comprising the step of moistening said substrate prior to feeding said substrate into said first application station, by a method selected from the group consisting of dipping said substrate in water, applying water to said substrate by atomization, or by exposing said substrate to a controlled humidity.

19. The method of claim 15 further comprising the step of laminating said substrate to a backing layer.
